(19) United States
(12) Patent Application Publication
(10) Pub. No.: US 2006/0137808 A1
(43) Pub. Date: Jun. 29, 2006

(54) Method for producing geotextiles with a defined isotropy from melt-spun filaments

(76) Inventors: Uwe Bornmann, Leonding (AT); Heinz Schorgenhuber, Linz (AT); Klaus Ahm, Linz (AT)

Correspondence Address: WENDEROTH, LIND & PONACK, L.L.P., 2033 K STREET N. W., SUITE 800, WASHINGTON, DC, 20006-1021, US

(21) Appl. No.: 10/533,909

(22) PCT Filed: Nov. 26, 2003
(86) PCT No.: PCT/EP03/13306

§ 371 Date: Dec. 5, 2005

(30) Foreign Application Priority Data
Nov. 27, 2002 (EP) 02026431.3

(51) Int. Cl. B32B 37/00; D04H 13/00

(52) U.S. Cl. 156/167; 156/148

(57) ABSTRACT

The invention relates to a method for producing geotextiles with a defined adjustable isotropy, particularly of the mechanical properties in the longitudinal transverse direction.

The invention relates to a method for producing geotextiles with defined adjustable isotropy, in particular of the mechanical properties, in the longitudinal and transverse direction.

DE 23 0 331 discloses extensive isotropic behavior of the property values in the longitudinal and transverse direction, for example by utilizing a vibrating baffle plate during the laydown of the fibers onto the transport belt.

AT 399 169 B describes a method for controlling the anisotropy of the properties of nonwoven fabrics in the longitudinal and transverse direction, in which the vibration frequency of the baffle plates is varied during the laydown of the fibers as a function of the desired ratio of the anisotropy.

The invention addresses the problem of providing a method for the production of geotextiles with defined isotropy, in which the desired mechanical properties are adjustable in each direction as defined.

Subject matter of the invention is therefore a method for producing geotextiles with defined isotropy, characterized in that the melt-spun filaments are laid down in at least two layers, the filaments in the first laydown being laid down through guide plates largely parallel next to one another and at an angle adjustable through the guide plates, and a second laydown in the same manner, however, such that it is mirror-inverted.

For the production of the filaments all thermoplastically processable synthetic materials can be employed, for example polyolefins, polyesters or polyamides, preferred are polyolefins, in particular polypropylene and polyesters.

The filaments are conventionally generated from the melt of the corresponding polymer, optionally with the addition of processing aids. The filaments or fibers extruded from a spinneret nozzle can be conventionally cooled and drawn. They are subsequently laid down onto a transport belt by means of a guide plate.

The laydown of the filaments preferably takes place largely parallel to one another via a guide plate. The laydown angle can therein be adjusted as defined by adjusting the guide plate. By laydown angle is understood an angle whose one leg is the guide plate and whose second leg represents an imaginary line drawn at right angles to the direction of production. Subsequently at least a second layer of filaments is laid down over the layer of filaments laid down so defined and specifically such that it is mirror-inverted.

By varying this angle the ratio of longitudinal strength to transverse strength can be selected as defined, wherein the greater this angle, the greater is the ratio of the longitudinal strength to the transverse strength. In this manner optionally several layers, each mirror-inverted, can be laid down over the preceding layer of filaments.

The nonwoven fabric laid down in the manner according to the invention can subsequently be solidified in the conventional manner and known needling methods as well as also water jet solidification methods can be employed.

Especially advantageously is therein employed a method for solidification in which the filaments are laid down in the manner according to the invention onto a screen belt, which subsequently transports the laid-down filaments at least to the first solidification stage.

The melt-spun filaments are thus initially laid down in the manner according to the invention onto the endless screen belt and transported on this screen belt to the first solidification stage. During the transport the laid-down filaments are fixed on the screen belt through suction zones such that no disturbances of the nonsolidified filaments can occur during the transport.

Depending on the disposition of the solidification device, in the first solidification stage the water jets act through the screen belt and/or the screen belt serves as a support mat.

After the solidification in the first solidification stage, the geotextile is sufficiently solidified such that it can be guided without experiencing any disturbance of the structure even without being supported by a transport belt. However, the screen belt can optionally also be guided through possible further solidification stages.

Consequently, the formation of the nonwoven fabric as well as also the solidification take place on the screen belt.

Due to this method it becomes possible to avoid any disturbance in the structure of the not yet solidified geotextile after it has been laid down. Complicated process controls, such as alternating guidance, can therefore be avoided.

The geotextiles produced in this manner are distinguished by high homogeneity and uniformity and by their defined mechanical properties in the longitudinal and transverse direction. The geotextiles produced according to the invention can therefore be utilized for reinforcement, as foundation or drainage installations in streets, roads, bridges, air port runways, embankments, dams and the like.

### EXAMPLE 1

Spunbonded fabric of PP, approximately 100 g/m²

Laydown angle 40°

Ratio of longitudinal to transverse tensile strength 1:1

### EXAMPLE 2

Spunbonded fabric of PP, approximately 100 g/m²

Laydown angle 55°

Ratio of longitudinal to transverse tensile strength 1.6:1

### EXAMPLE 3

Spunbonded fabric of PP, approximately 100 g/m²

Laydown angle 35°

Ratio of longitudinal to transverse tensile strength 0.7:1

### EXAMPLE 4

Spunbonded fabric of PET, approximately 300 g/m²

Laydown angle 43°

Ratio of longitudinal to transverse tensile strength 1:1

### EXAMPLE 5

Spunbonded fabric of PET, approximately 300 g/m²

Laydown angle 53°

Ratio of longitudinal to transverse tensile strength 1.5:1

1. Method for the production of geotextiles with defined isotropy, wherein the melt-spun filaments are laid down in at least two layers, wherein the filaments in the first laydown are laid down through guide plates largely parallel next to one another and at an angle adjustable through the guide plates, and in a second laydown in the same manner, however, such that it is mirror-inverted.

2. Method as claimed in claim 1, wherein the laydown angle is 20 to 70 degrees.

3. Method as claimed in claim 1, wherein the laydown angle is 20 to 70 degrees, wherein after solidification the ratio of longitudinal to transverse wide width tensile strength is 3.5:1 to 0.3:1.

4. Method as claimed in claim 1, wherein two to ten layers are laid down.

5. Method as claimed in claim 1, wherein the filaments laid down are subsequently water-jet solidified or needled.

6. Method as claimed in claim 5, wherein the filaments are laid down on an endless screen belt, transported on this screen belt through the first solidification stage, wherein the filaments during the entire process are additionally fixed on the screen belt through suction zones and, in this manner, are already sufficiently solidified in the first solidification stage such that the disturbance-free transport without transport belt is possible.

7. Geotextiles produced as claimed in claim 1.

8. Method for providing reinforcements, foundations or drainage installations which comprises employing the geotextiles of claim 7 therein.

9. Method according to claim 7 wherein said reinforcements, foundations or drainage installations are in streets, roads, bridges, airport runways, embankments, or dams.
